(19) United States
(12) Patent Application Publication
(10) Pub. No.: US 2004/0120235 A1
(43) Pub. Date: Jun. 24, 2004

(54) Recording/reproducing apparatus and method for laser power control during CAV recording

(75) Inventor: Yasuhisa Koide, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 10/729,597

(22) Filed: Dec. 5, 2003

(30) Foreign Application Priority Data
Dec. 6, 2002 (JP) 2002-354720

(51) Int. Cl. G11B 7/125

(52) U.S. Cl. 369/47.53

(57) ABSTRACT

Technology is provided allowing recording to be always conducted at the optimum laser power, regardless of the recording location on the disk. A target reflected light level (target B level) at which the optimum laser power is obtained is found by conducting test writing in a test write area, recording is started at an angular velocity corresponding to a linear velocity in the vicinity of the innermost periphery, and the rotation frequency is increased to a target rotation frequency, while controlling the laser power so as to obtain the target B level. Furthermore, the relation between the linear velocity and optimum laser power obtained at this time is recorded. The laser power may be also controlled so as to obtain the preset β value, instead of controlling the laser power so as to obtain the target B level.

### BACKGROUND OF THE INVENTION

1. Field of the Invention

The present invention relates to a technology for rotating an optical disk by a CAV (Constant Angular Velocity) system and conducting control such that the laser power during data recording becomes the optimum power.

2. Description of the Related Art

When recording in recording apparatuses is conducted by rotating an optical disk with a CAV system, the linear velocity linearly increases toward the outer periphery of the disk because the angular velocity is constant. If a laser emits light at a constant power when the linear velocity increases, the quantity of heat irradiated on the recording surface of the optical disk gradually decreases. For this reason, it is necessary to raise the emission power of the laser according to the increase in velocity in order to preserve the recording quality. The OPC (Optimum Power Calibration) may be conducted at various linear velocities and recording quality may be evaluated to obtain the optimum power (referred to as an optimum laser power or, simply, optimum power) of the laser corresponding to velocity increase, but when the test-writing area (referred to as PCA: Power Calibration Area) is provided only on the innermost periphery and a linear velocity comparable to that of the outer periphery of CAV recording is attempted, the optical disk has to be rotated at an ultrahigh velocity. However, such a rotation at an ultrahigh velocity is not suitable for practical use because it causes destabilization, e.g. of servo.

With the conventional technology capable of resolving this problem and recording good-quality recording data, a first test writing and a second test writing at a linear velocity different from that of the first test writing are conducted, a light beam power and a frame time interval are plotted on the vertical and horizontal axes, respectively, and a linear function is computed which connects values obtained in the first and second test writings. Because the light beam power and the frame time interval are directly proportional to each other, a CPU computes the light beam power of the optimum amount corresponding to the frame time interval based on the linear formula (for example, Japanese Patent Application Laid-open No. 2002-183961, see FIG. 5).

### SUMMARY OF THE INVENTION

With the above-described conventional technology, the optimum power in the second test writing with a laser beam power different from that of the first test writing was linearly approximated, the optimum power at the outer periphery of the optical disk was approximated, and recording was conducted with this power. However, the linear approximation is not always accurate and there is still room for improvement of recording quality.

It is an object of the present invention to provide a recording technology capable of resolving the above-described problems and emitting a light beam at a recording power corresponding to a recording location on the optical disk when recording is carried out with the CAV system.

In order to attain the object of the present invention, the recording/reproducing apparatus of the first aspect of the present invention comprises a laser for emitting a laser beam onto an optical disk and recording a data; a laser driver for outputting to the laser a voltage corresponding to the emitted light waveform obtained by converting the recording data; light receiving means for receiving the reflected light of the laser beam emitted onto the optical disk; a light pick-up comprising the laser and the light receiving means and movable in the radial direction of the optical disk; a motor for rotating the optical disk; a motor driver for controlling the rotation speed of the motor; test write means for controlling the laser driver and the light pick-up and conducting test writing by changing the laser power in a test writing area provided in the optical disk; and means for evaluating the test-written data and setting the value of the reflected light corresponding to the preferred recording laser power as a target reflected light value, wherein the motor driver starts recording at a linear velocity in the test writing area and controls the rotation speed of the motor so as to reach gradually the target angular velocity when data is recorded from any location on the optical disk, and the laser driver conducts a running OPC for controlling a voltage supplied to the laser, so that the value of the reflected light obtained with the light receiving means becomes the target reflected light value during a recording period from the recording start till the target angular velocity is reached.

A laser power control method of the second aspect of the invention comprises the steps of acquiring a reflected light level, which is preferred during recording, by test writing into a test writing area provided in an optical disk, and conducting a running OPC for controlling the laser so as to obtain the preferred reflected light level, while considering the linear velocity at the recording start location as a linear velocity on the inner peripheral side of the optical disk and gradually increasing the rotation speed after the recording start till the target rotation speed of said disk is reached.

### BRIEF DESCRIPTION OF THE DRAWINGS

FIG. 1 is a block diagram illustrating a working example of the recording/reproducing apparatus according to the present invention;

FIG. 2 is a waveform diagram illustrating the waveform of the reflected light and laser beam during recording;

FIG. 3 is a characteristic diagram illustrating the relation between the radial location and linear velocity of an optical disk;

FIG. 4 is a characteristic diagram illustrating the relation between the linear velocity and laser power obtained by the running OPC;

FIG. 5 is a characteristic diagram illustrating the relation between a radial location of the disk and a rotation frequency of the optical disk

FIG. 6 is a characteristic diagram relating to the case in which the rotation frequency was increased in stages;

FIG. 7 is a flow chart illustrating a working example of processing operation of stage-like control of the laser power according to the present invention; and

FIG. 8 is a waveform diagram illustrating a laser beam generation waveform for explaining the method for laser power control.

### DETAILED DESCRIPTION OF THE PREFERRED EMBODIMENTS

The main reference symbols used in the drawings are as follows:

101—an optical disk, 102—an optical pick-up, 103—a spindle motor, 104—an I-V amplifier, 105—a laser control driver, 106—a spindle motor control driver, 107—a focusing and tracking processing unit, 108—an analog signal processing circuit, 109—a reflected light processing unit, 110—a recording pulse generator, 111—a spindle control circuit, 112—an asymmetry processing unit, 113—an equalizer, 114—a wobble processing unit, 115—an encoder, 116—a PLL circuit, 117—a binarization circuit, 118—a decoder, and 119—an MPU.

The preferred embodiment of the present invention will be described hereinbelow by using working examples thereof with reference to the accompanying drawings.

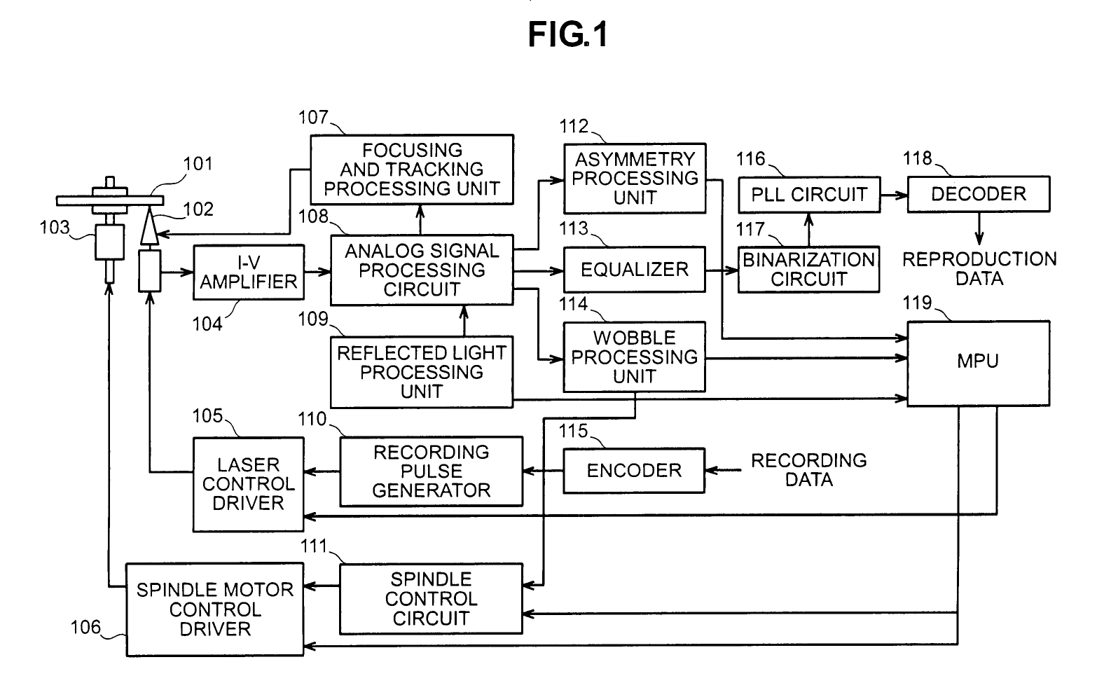

FIG. 1 is a block diagram illustrating a working example of the recording/reproducing device according to the present invention. As shown in the figure, an optical disk 101 is illuminated with a laser beam from a light pick-up 102. Furthermore, the reflected light that was reflected from the optical disk 101 is detected by a photodetector of the light pick-up 102, and the output of the photodetector is converted into a voltage in an I-V amplifier 104. Further, in the present embodiment, the light pick-up 102 is composed of a semiconductor laser, an optical system such as an objective lens, a focusing actuator, a tracking actuator, a photodetector, and a lens position sensor.

The output of the I-V amplifier 104 is inputted into an analog signal processing circuit 108, where the output of the I-V amplifier 104 is computed, a focus error signal, a tracking error signal, and a wobbling signal are generated, these signals are inputted into focusing and tracking processing units, and focusing actuator and tracking actuator control is conducted based on the focus error signals and tracking error signals. The wobbling signal obtained from the analog signal processing circuit 108, i.e., the RF signal, is subjected to waveform equalizing in an equalizer 113, converted into a binary signal in a binarization circuit 117, and inputted into a PLL circuit 116. In the PLL circuit 116, a channel clock is generated form the binary signal and inputted into a decoder. The binary signal is decoded in the decoder 118 with the channel clock produced in the PLL circuit 116 and data is demodulated. Therefore, a reproduction data is obtained at the output terminal of decoder 118.

The reference numeral 109 stands for a reflected light processing unit for processing the binarized data corresponding to the reflected light obtained from the optical disk 101 when writing has been conducted in a power calibration area (PCA). The output of the reflected light processing unit 109 is inputted into an MPU 119, and fine tuning of parameters set into a laser driver 105 is carried out by the output of the MPU 119. Therefore, running OPC (Optimum Power Calibration) can be conducted by using the output of the reflected light processing unit 109. The reference numeral 112 stands for an asymmetry processing unit which produces beta (β) relating to each recording power from the RF signal outputted from the analog signal processing circuit 108. Therefore, inputting the data into the MPU 119 makes it possible to determine the optimum power level based on the β value. Further, the MPU 119 conducts supply of the clock or control signal to each circuit, processing of interrupt signal, control of firmware, and the like. The reference numeral 114 stands for a wobble processing unit. Here, a wobble period is produced from the wobbling signal generated in the analog signal processing circuit 108. The data is inputted into the MPU 119 and spindle control circuit 111. The wobble period is used for clock generation and spindle control. Furthermore, a sync frame timing inside a sector can be also produced by the wobble period.

A recording data is subjected to 8/16 modulation in an encoder 115 and inputted into a recording pulse generator 110. In the recording pulse generator 110, an NRZI is generated from the modulated data, which was inputted from the encoder 115, and outputted into the laser control driver 105. In the laser control driver 105, the inputted NRZI signal is converted into a light emission waveform and control of power level of the semiconductor laser (not shown in the figures) and light emission pulse width is conducted.

A spindle control circuit 111 generates a frequency for driver drive from a wobble signal inputted from the wobble processing unit 114 and a signal inputted from a fixed period generator of the MPU 119. A spindle control driver 106 converts a constant frequency corresponding to a velocity increase inputted from the spindle control circuit 111 and drives a spindle motor 103 at the time of CAV control. Furthermore, at the time of CLV control, a variable frequency generated based on the wobble signal period that was inputted from the spindle control circuit 111 is converted into a voltage and supplied to the spindle motor 103.

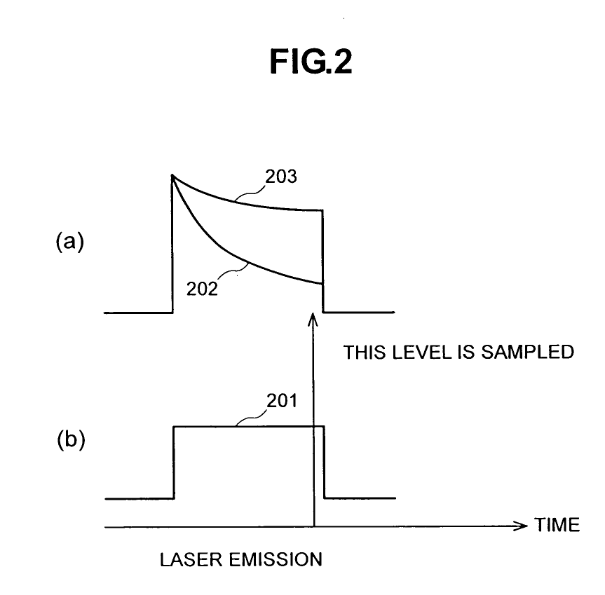

The running OPC will be described below by using FIG. 2.

FIG. 2 is a waveform diagram illustrating the waveforms of reflected light and laser during recording. FIG. 2A shows the reflected light obtained when a mark is recorded on an optical disk, and FIG. 2B shows a light emission pulse of the laser. The reference symbol 202 denotes a characteristic line of reflected light obtained when a mark has been formed correctly, and the reference 203 denotes a characteristic line obtained when the mark has not been written correctly, those characteristic lines relating to the case in which a mark has been recorded on the optical disk with a laser pulse 201 shown in FIG. 2B. When a mark was steadily formed on the optical disk, attenuation of the reflected light was observed at the instant of time t. The quantity of reflected time at the instant of time t relating to the case in which the mark was written correctly becomes constant regardless of the writing speed on the optical disk. Therefore, the optimum power can be obtained by controlling the laser power so that the reflected light at the instant of time t becomes constant. In other words, the running OPC is a control of laser power conducted so that the reflected light obtained during recording assumes the prescribed constant value, and employing the running OPC makes it possible to conduct recording with the optimum laser power. In the working example shown in FIG. 1, the parameters set into the laser control driver are finely tuned so that the output of the reflection light processing unit 109 assumes the prescribed value during recording.

In order to obtain the reflected light which allows the value of optimum power to be obtained, test writing is conducted in the PCA and the optimum power is found by reproduction and evaluation thereof. Furthermore, the quantity of reflected light at this time is recorded. With the OPC, parameters set in the laser control driver 105 are finely tuned so that this reflected light be obtained. Thus, recording with an almost optimum laser power can be carried out by finding the reflected light at which optimum power is obtained (referred to hereinbelow as an optimum reflected light) by test writing and conducting the running OPC such that recording is advanced, while conducting fine tuning of the parameters set in the laser control driver 105, so as to obtain the optimum reflected light that was thus found.

The optimum laser power or optimum power as referred to according to the present invention is a laser power that is included in an error range of the β value (asymmetry value), which is determined by the medium, by conducting test writing by changing the laser power in the PCA and evaluating the reproduced data.

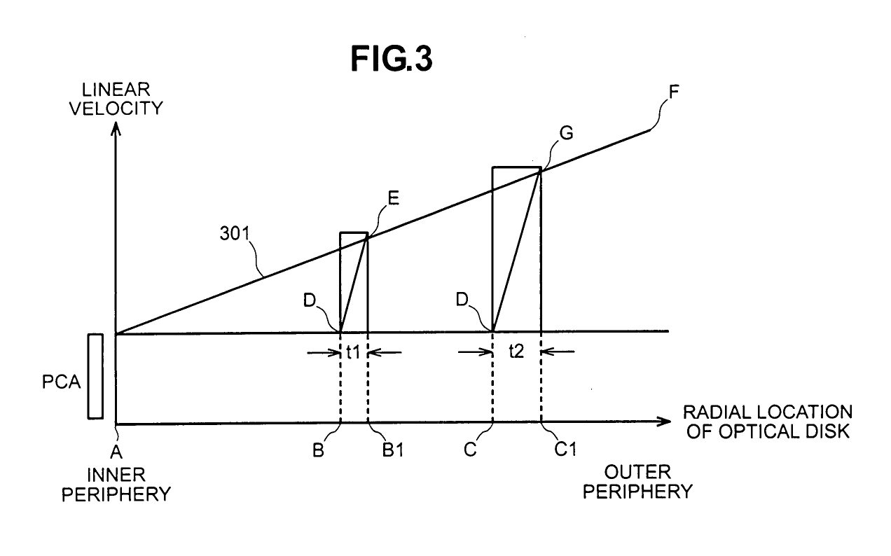

A method for controlling the power of CAV recording according to the present invention will be described below with reference to FIG. 3.

FIG. 3 is a characteristic diagram illustrating the relation between a radial location on an optical disk and a linear velocity. In the figure, a radial location on the optical disk is plotted against the horizontal axis, and a linear velocity is plotted against the vertical axis. When the CAV control is carried out so as to rotate the optical disk at the prescribed angular velocity, the linear velocity increases as the radial location on the disk moves to the outer periphery thereof. A characteristic line 301 indicates a linear velocity related to the radial location on the disk in this case. When the optical disk is CAV controlled, the linear velocity rises as the radial location moves to the outer periphery of the disk, as shown by the characteristic line 301. It is usually necessary to increase the laser power as the linear velocity increases, but the quantity of light reflected from the optical disk in the vicinity of optimum power is almost constant.

In the present working example, the reflected light obtained when test writing in the CPA was carried out at a linear velocity of the inner periphery of the CAV is stored, for example in a memory of MPU 119. In the case of disks in which recording can be conducted only once, such as disk-at-once systems, recording is started in the usual fashion from the recording start location A on the inner periphery of the optical disk. In this case, user's data is recorded, while controlling the rotation of the optical disk by the CAV system and controlling the laser beam power by the running OPC so that the reflected light becomes constant. Thus, recording is conducted, while the linear velocity is changed along the characteristic line 301 and the laser power is controlled by the running OPC.

However, the user's data recording start location in the case of write-once recording and when a certain low volume is recorded is, for example, a recoding start location B, rather than the recording start location A. In this case, if a transition is made to a linear velocity of CAV depending on the recording start location B on the disk, because the optimum power of laser at this linear velocity is not known, the optimum power obtained by linear approximation is given, as in the conventional example. There are, however, cases when a sufficient recording quality cannot be maintained at the laser power obtained by linear approximation.

In the present embodiment, recording is initially started at an angular velocity corresponding to the linear velocity on the innermost periphery of the CAV. Thus, in the recording start location B, recording is started at an angular velocity corresponding to the linear velocity on the innermost periphery of the CAV. The angular velocity is thereafter gradually raised to the prescribed CAV value, while controlling the laser power by the running OPC so that the reflected light becomes constant. In this case, the linear velocity changes as D, E, F, where D stands for a linear velocity corresponding to the location B on the disk, E stands for a linear velocity on the characteristic line 301 which is to be assumed in the disk location B1 after a time t1 has elapsed, and F stands for a linear velocity on the characteristic line 301 on the outermost periphery of the disk.

Referring to FIG. 3, when write-once recording has been started from the recording start location C which is positioned further to the outer periphery side, the recording is started at an angular velocity corresponding to the linear velocity (linear velocity in the recording start location C) on the innermost periphery of CAV and the angular velocity is then gradually increased to the angular velocity of CAV at the characteristic line 301, while conducting the running OPC. In other words, recording is started from the linear velocity D, the linear velocity is then increased to a linear velocity G at the characteristic line 301 corresponding to the disk recording location C1 after a time t2, then the linear velocity is increased so as to follow the characteristic line 301 (the CAV value is increased so that the prescribed CAV value is attained), and the linear velocity is changed so that the linear velocity F is reached. The increase rate of angular velocity, or the increase rate of linear velocity, which is the slope of line DE or line DG, may assume any value, provided that tracking with the running OPC is possible.

Furthermore, the relation between the linear velocity and the laser beam power obtained with the running OPC during the increase period required to reach the linear velocity corresponding to the angular velocity of the usual CAV, that is, within the time t1 of line DE or the time t2 of line DG, is recorded periodically together with the disk ID into the memory of the optical disk recording apparatus.

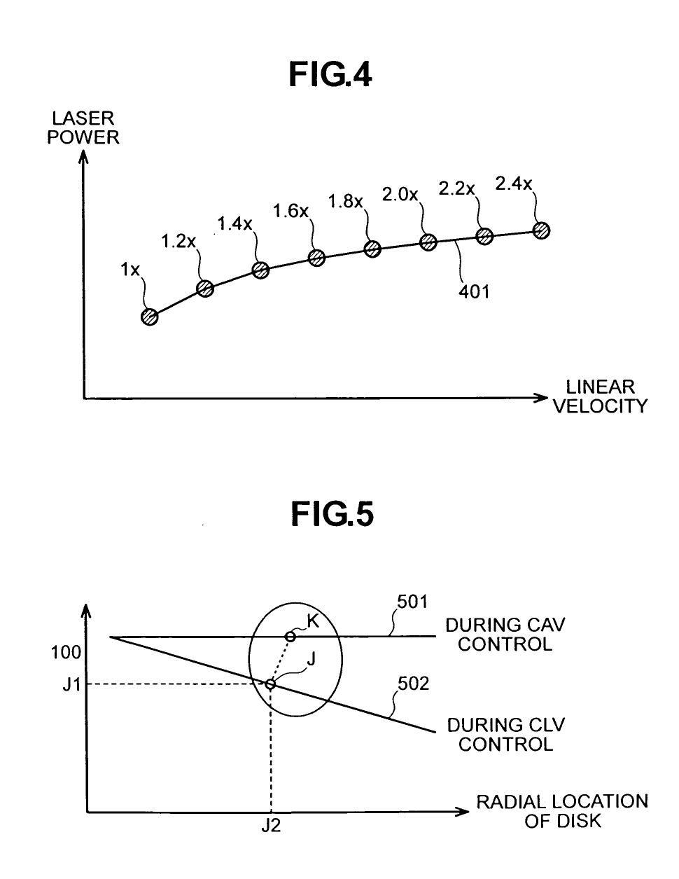

FIG. 4 illustrates the relation between the linear velocity and the laser power obtained with the running OPC. In the figure, the linear velocity is plotted against the horizontal axis, and the laser power is plotted against the vertical axis. The characteristic line 401 in the figure is the characteristic diagram of optimum laser power and the linear velocity obtained by the running OPC between the disk recording locations B-B1, C-C1 shown in FIG. 3, and shows the optimum laser power obtained when the linear velocity changed from 1× to 2.4×. This data is also recorded into the memory of the disk recording apparatus.

FIG. 4 shows a characteristic line obtained when the rotation was controlled with the prescribed CAV at which the linear velocity was 1× to 2.4×. However, because the linear velocity 1× can change within 1×-10×, and the linear velocity 2.4× can change within 2.4×-24×, the linear velocity differs depending on the rate increase ratio at which the CAV control is being conducted. Accordingly, the linear velocity shown in FIG. 4 assumes a value within 1×-10×, 1.2×-12×, 1.4×-14×, . . . 2.4×-24×, depending on the CAV value during recording on this optical disk.

As described hereinabove, in the present embodiment, parameters can be set into a laser control driver by computing the optimum power in a recording location from the relation between the linear and laser power stored in the memory. Therefore, when recording is conducted prior to the recording location B on the disk, or on the inner side with respect to the recording location C, the laser power can be tracked by the running OPC from this location. Furthermore, when the optical disk is unloaded, the relation between the laser power and the linear velocity is written on the optical disk, and when the disk is then loaded, the optimum laser power of CAV recording can be computed and set based on this information. Therefore, time required to obtain the optimum power can be shortened.

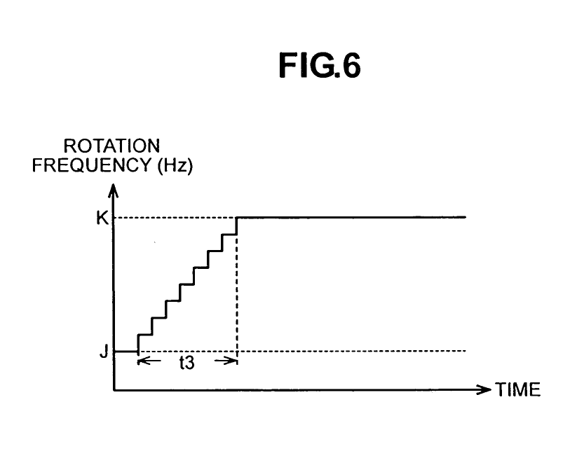

The other working example of the present invention will be described hereinbelow with reference to FIGS. 5 and 6.

FIG. 5 is a characteristic line illustrating the relation between the radial location on the disk and the rotation frequency of the optical disk. In the figure, the radial location on the disk is plotted against the horizontal axis, and the rotation frequency (Hz) is plotted against the vertical axis. In the figure, the characteristic line 501 shows the target frequency in the case of prescribed CAV control of the optical disk, this target frequency being the same in all the radial locations of the disk. The characteristic line 502 shows the rotation frequency in the case of CLV control. With the CLV (Constant Linear Velocity) control, the linear velocity is controlled so as to be constant in all the radial locations on the disk. Therefore, the rotation frequency is controlled so as to decrease toward the outer periphery of the disk.

In the present embodiment, the CLV control is conducted to the rotation frequency J1 corresponding to the disk radial location J2 where writing is started, and the running OPC control is carried out by raising the rotation frequency from the write start frequency J to the target rotation frequency K in stages.

The case in which the running OPC is conducted in stages by increasing the rotation frequency in stages from the rotation frequency of write start till the target rotation frequency is reached will be described hereinbelow with reference to FIG. 6.

FIG. 6 is a characteristic diagram relating to the case in which the rotation frequency is increased in stages. In the figure, the time is plotted against the horizontal axis and the rotation frequency of the disk is plotted against the vertical axis. This figure illustrates the case in which the rotation frequency is increased separately in 8 stages by conducting the running OPC from the rotation frequency J to the target rotation frequency. The rotation frequency is increased in stages by a method in which the reflected light is observed at the rotation frequency of each stage and the one-stage rotation frequency is increased when the reflected light becomes within the specific error range.

The following two methods can be used for increasing the rotation speed from the rotation frequency J to the rotation frequency K: (1) a method in which the time is determined according to the radial location on the disk from the inner periphery and the rotation frequency is increased to the target rotation frequency within this time t3 (the rotation frequency which is increased in one cycle is limited), and (2) a method in which the running OPC is carried out by determining the width of each stage, while observing the state of the running OPC of each stage, without determining the time t3 based on the location on the disk and the rotation frequency is increased till the target rotation frequency is reached. The drawbacks of method (2) are that the program is complex and the operations are time consuming, but the method is applicable to any optical disk.

In the present embodiment, the optimum laser power is obtained by conducting the running OPC in each stage. Therefore, the optimum laser power can be instantly recorded by storing the obtained optimum laser power in a memory.

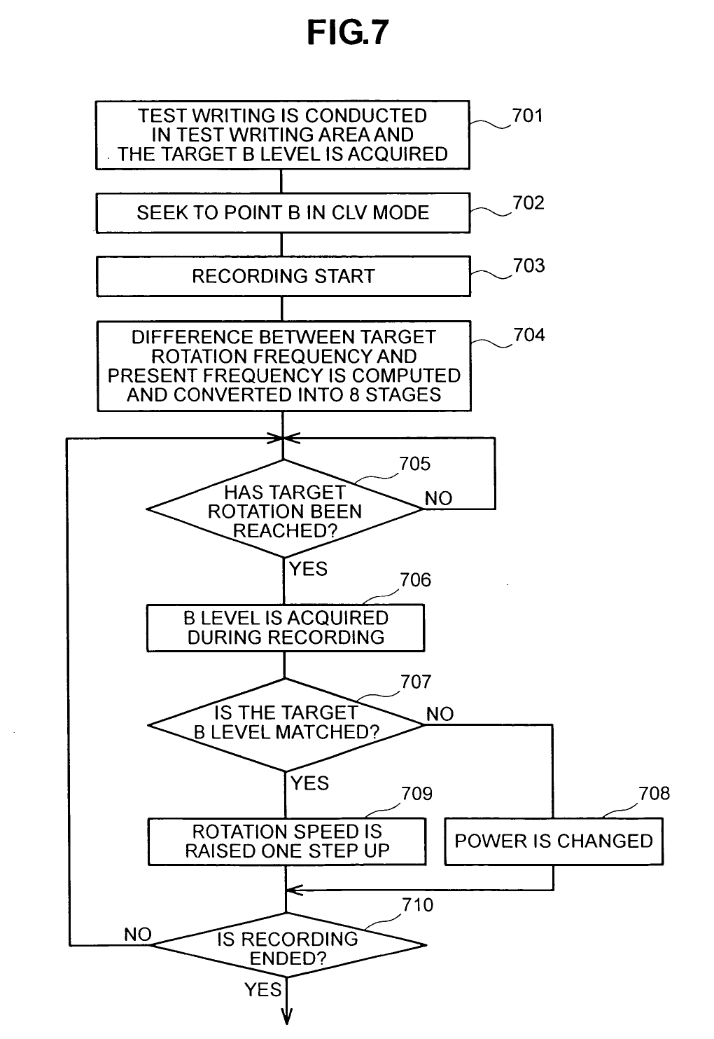

The processing executed to reach the target rotation frequency, while conducting the running OPC in stages from the recording start rotation frequency to the target rotation frequency will be described hereinbelow with reference to FIG. 7.

FIG. 7 is a flow chart illustrating a working example of processing operation of stage-like control of the laser power according to the present invention.

In step 701, a test writing is conducted in the test writing area (PCA), the test write data is evaluated and the quantity of reflected light (will be referred to as a target B level) at the optimum laser power is stored. Then, in step 702, a search is made in an CLV mode to the recording start location (B location in FIG. 3, J2 location in FIG. 5). In step 703, recording is started from the recording start location. In this case, switching is made from the CLV mode to the CAV control. In step 704, the difference between he target rotation frequency and the present rotation frequency is computed and a stage for switching is determined. In the present embodiment, setting is made to 8 stages. In step 705, it is decided whether the target rotation frequency has been reached, and if the target rotation frequency has not been reached (Y), in step 706, the B level (quantity of reflected light) during recording is acquired. In step 707, it is decided as to whether the B level acquired in step 706 matches the target B level (the quantity of reflected light for which the optimum laser power is obtained), and if there is no match (N), in step 708, the laser power is changed and the processing flow moves to step 710. If the target B level was matched (Y) in step 707, then in step 709, the rotation frequency is increased by one stage and in step 710 a decision is made as to whether the recording has ended (whether the target rotation frequency has been reached). If the recording has ended, the processing is ended. If the recording was not ended in step 710, the processing flow returns to step 705, and the same operations are repeated.

In the embodiment illustrated by FIG. 7, a method was used by which the rotation frequency was increased by stages, while checking the B level, but the rotation frequency can be also increased in a stepless manner. In this case, a rotation frequency increase rate is set in advance and an electric current supplied to the spindle motor is gradually increased. The rotation frequency increase rate may be reduced to a degree that can be traced by the running OPC. Because the rotation of the spindle motor is usually controlled by voltage, a current fluctuation limiter is used when the target voltage is set.

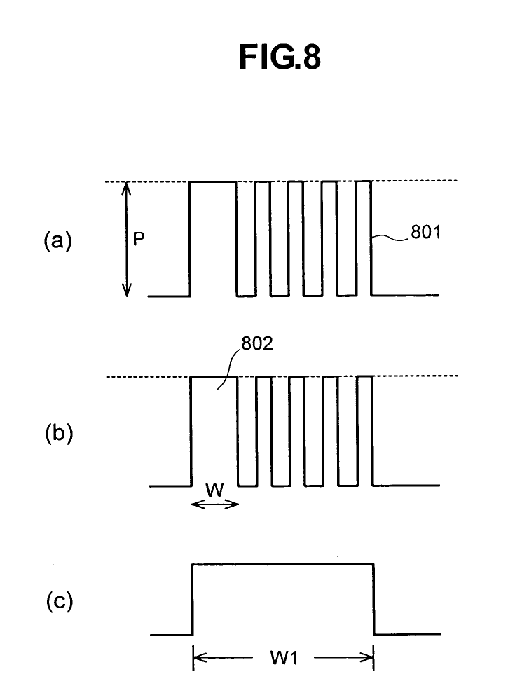

A method for controlling the optimum laser power will be described hereinbelow with reference to FIG. 8.

FIG. 8 is a waveform diagram illustrating the laser beam generation waveform for explaining a method for controlling the laser power. FIG. 8A shows a pulse-shaped laser waveform; in this case, the laser power is controlled by changing the peak power P of the pulse-shaped laser waveform 801. FIG. 8B shows a pulse-shaped laser waveform; in this case, the laser power is controlled by changing the pulse width W of the leading laser pulse 802 in the pulse-shaped laser waveform. FIG. 8C shows a monopulse laser waveform; in this case, the laser power can be controlled by changing the entire width W1 of the pulse.

In the above-described embodiment, the reflected light level (B level) of the optimum laser power was obtained by conducting test writing in the PCA and the running OPC was carried out by using this B level, but in the case of a recording method employing RAW (Read After Write) for immediately reproducing the recorded sector to evaluate the quality, it is also possible to use a β value (asymmetry value) that can be acquired for each reproduction, instead of the B level. Because the optimum β value is determined by the medium, the optimum laser power is obtained by controlling the laser power so that the β value obtained from the asymmetry processing unit 112 shown in FIG. 1 becomes the optimum β value. Therefore, fine adjustment of the power may be conducted by using the optimum β value.

As described hereinabove, according to the present invention, the quantity of reflected light (B level) at which the optimum laser power is obtained is acquired and the running OPC is conducted by writing the test write data in a test write area (PCA), while varying the laser power, and reproducing and evaluating the test write data. First, recording is started at a linear velocity of the inner periphery of the disk in the recording start location of the disk, the linear velocity is then increase gradually, while conducting the running OPC by using the acquired B level, and the linear velocity is raised till the linear velocity of the target rotation frequency is attained. Furthermore, the disk ID and the relation between the linear velocity and optimum laser power that was obtained in the running OPC are stored in the memory of the recording apparatus. Furthermore, when the disk is unloaded, the obtained B level and the relation between the location on the disk and the optimum laser power are stored in the disk.

As described hereinabove, according to the present invention, the optimum laser power can be maintained.

Furthermore, because the relation between the linear velocity and optimum laser power that was obtained in the running OPC is stored together with the disk ID in the memory and can be reused, the optimum laser power can be rapidly obtained.

Furthermore, storing the relation between the linear velocity and optimum laser power in the disk makes it possible to use it when the disk is reproduced. Therefore, the optimum laser power can be instantly obtained.

What is claimed is:

1. A recording/reproducing apparatus comprising:
a laser for emitting a laser beam onto an optical disk and recording a data;
a laser driver for outputting to said laser a voltage corresponding to the emitted light waveform obtained by converting the recording data;
light receiving means for receiving the reflected light of the laser beam emitted onto said optical disk;
a light pick-up comprising said laser and light receiving means and movable in the radial direction of said optical disk;
a motor for rotating said optical disk;
a motor driver for controlling the rotation speed of said motor;
test write means for controlling said laser driver and light pick-up and conducting test writing by changing the laser power in a test writing area provided in said optical disk; and
means for evaluating the test-written data and setting the value of the reflected light corresponding to the recording laser power as a target reflected light value,
wherein said motor driver starts recording at a linear velocity in said test writing area and controls the rotation speed of said motor so as to reach the target angular velocity when data is recorded from any location on said optical disk, and
said laser driver conducts a running OPC for controlling a voltage supplied to said laser so that the value of the reflected light obtained with said light receiving means becomes said target reflected light value during a recording period from the recording start till the target angular velocity is reached.

2. The recording/reproducing apparatus according to claim 1, wherein said motor driver conducts a CLV control to said recording start location and conducts a CAV control after said target angular velocity has been reached.

3. The recording/reproducing apparatus according to claim 1, wherein an asymmetry processing unit is provided and the laser driver is controlled so that an asymmetry value (β value) which is set by the optical disk is assumed.

4. The recording/reproducing apparatus according to claim 1, wherein said motor driver rises the rotation speed of said motor in stages during the recording period from the recording start till the target angular velocity is reached.

5. The recording/reproducing apparatus according to claim 1, wherein the relationship between the laser power and linear velocity obtained with said running OPC is stored in a memory.

6. A laser power control method comprising the steps of:
acquiring a reflected light level during recording by test writing into a test writing area provided in an optical disk; and
conducting a running OPC for controlling the laser so as to obtain said reflected light level, while considering the linear velocity at the recording start location as a linear velocity on the inner peripheral side of the optical disk and increasing the rotation speed after the recording start till the target rotation speed of said disk is reached.

7. The laser power control method according to claim 6, wherein:
a CLV control is conducted to a recording start location and a CAV control is conducted after said target rotation speed has been reached.

8. The laser power control method according to claim 6, wherein:
said rotation speed is changed in stages during the recording period from the recording start till the target rotation speed is reached and said running OPC is carried out at each stage.

9. The laser power control method according to claim 6, wherein:
the time from the recording start till the target rotation speed is reached is preset according to the recording location.

10. The laser power control method according to claim 6, wherein:
the relation between the laser power and linear velocity obtained with said running OPC is stored.

11. The laser power control method according to claim 6, wherein:
the relation between the laser power and linear velocity obtained with said running OPC is stored in a medium.
